(19) United States
(12) Patent Application Publication
(10) Pub. No.: US 2014/0358286 A1
(43) Pub. Date: Dec. 4, 2014

(54) BUILDING MANAGEMENT SYSTEM

(71) Applicant: HITACHI, LTD., Tokyo (JP)

(72) Inventor: Osamu KOBAYASHI, Tokyo (JP)

(73) Assignee: HITACHI, LTD., Tokyo (JP)

(21) Appl. No.: 14/262,851

(22) Filed: Apr. 28, 2014

(30) Foreign Application Priority Data
May 31, 2013 (JP) 2013-114804

(51) Int. Cl. G05B 15/02

(52) U.S. Cl. CPC G05B 15/02
USPC 700/275

(57) ABSTRACT

An operation control apparatus and an operation control system are provided in which facility equipment operation is performed according to a facility environment. In the building management system including a facility equipment and a control device to control the facility equipment, the control device obtains an operation time in an intermittent operation of the facility equipment based on a second in-room people number ratio obtained by multiplying a first in-room people number ratio, which is a ratio of an actual in-room people number to a maximum in-room people number in an area where the facility equipment is provided, by a multiplying factor whose value becomes large as an operation necessity of the facility equipment becomes high.

### BACKGROUND OF THE INVENTION

1. Field of the Invention

The present invention relates to an operation control apparatus and an operation, control system.

2. Description of Related Art

Energy saving in a building is required, and needs for a high-performance building management system, which achieves energy saving by totally controlling facilities, such as electric/air conditioning/heat source facilities, operating in the building, becoming high. For example, there is an intermittent operation control to achieve energy saving by alternatively sending “turn-on” output and “turn-off” output to the operating facilities at constant time intervals.

The intermittent operation control is one of automatic controls. The “turn-on” time and “turn-off” time are inputted from the screen of the building management system, so that the “turn-on” output is sent at the set time to the facility, and then, the “turn-off” output is sent. After that, the “turn-on” and “turn-off” outputs are repeated until a stop instruction is outputted from the building management system.

As a related art technique, there is JP-A-2002-39578 (Patent Literature 1). This literature discloses providing a presence/absence switching unit to recognize whether a person is present or absent in a building, a humidity/dust detection unit installed in the building, and a controller to control a ventilation fan to produce a small quantity of air or to be intermittently operated based on the absence signal recognized by the presence/absence switching unit and to temporarily stop the ventilation fan based on the signal from the humidity/dust detection unit.

JP-A-9-001170 (Patent Literature 2) discloses that a power saving septic tank, which achieves the above object, includes a utilization degree detection unit to detect data on the number of users using facilities, and a control unit to cause a blower to supply the air of quantity based on the data detected by the utilization degree detection unit.

In the intermittent operation control disclosed in JP-A-2002-39578, “turn-on” and “turn-off” are outputted at an intermittent time interval which is a previously set time interval (constant time interval). Thus, the “turn-on” and “turn-off” control outputs are always sent to the facility equipments at the constant time interval irrespective of room environments such as season, the number of people present in the room, and the day of the week. Accordingly, unnecessary output exceeding the environmental condition may be performed.

JP-A-9-001170 discloses that in view of the fact that the utilization rate of the facilities varies according to the day of the week, when the utilization rate is 50%, the operation rate is controlled to 50%. The control is performed while the utilization rate is used as the operation rate. However, if the utilization rate is directly used as the operation rate, since the facility environment (for example, the temperature change in the facility) is not reflected, it is difficult to achieve the comfortableness according to the facility environment and the intermittent operation with high energy-saving effect.

### SUMMARY OF INVENTION

The invention provides an operation control apparatus and an operation control system, in which facility equipment operation is performed according to a facility environment.

In order to solve the above problem, according to the invention, in a building management system including a facility equipment and a control device to control the facility equipment, the control device obtains an operation time in an intermittent operation of the facility equipment based on a second in-room people number ratio obtained by multiplying a first in-room people number ratio, which is a ratio of an actual in-room people number to a maximum in-room people number in an area where the facility equipment is provided, by a multiplying factor whose value becomes large as an operation necessity of the facility equipment becomes high.

According to the invention, the facility equipment operation can be performed according to the facility environment.

### BRIEF DESCRIPTION OF THE DRAWINGS

FIG. 1 is a system structural view of the invention.

FIG. 2 is a processing flow of intermittent time calculation.

FIG. 3 shows dates and dairy multiplying factors.

FIG. 4 is a view for explaining a method of calculating a “turn-on” time and a “turn-off” time in an operation time of one hour based on a second in-room people number ratio.

### DESCRIPTION OF EMBODIMENTS

Hereinafter, embodiments will be described with reference to the drawings.

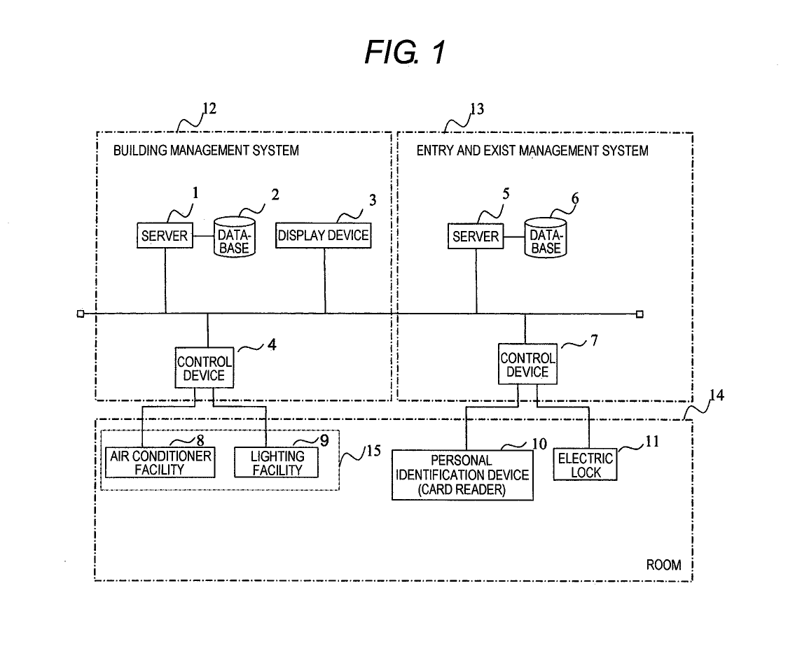

FIG. 1 is a system structural view of the invention.

This system includes a building management system 12, an entry and exit management system 13 and a room 14.

First, the building management system 12 will be described.

The building management system 12 includes a server 1, a database 2, a display device 3 and a control device 4, and these are connected to each other through a LAN network or the like.

The server 1 stores information, which is gathered by the control device 4, of a facility equipment 15 (an air conditioner facility 8, a lighting facility 9, etc.) provided in the room 14 into the database 2. Besides, the server 1 creates display data to the display device 3. Further, the server 1 acquires an in-room people number in the room based on a control device 7 provided in the entry and exit management system 13 described below, entry and exit history information stored in a database 6, and the like.

The display device 3 is an interface device used by the user of the building management system 12, and displays data of the state of the facility equipment transmitted from the server 1. Besides, the display device 3 receives control setting information from the user and can transmit it to the server 1.

The information on the control setting inputted from the display device 3 is stored in the database 2 through the server 1. The control setting information stored in the database 2 is transmitted to the control device 4 through the network.

The control device 4 sends “turn-on” and “turn-off” control outputs to the facility equipment 15 based on the control setting information stored in the database 2. With respect to the control outputs, for example, when intermittent operation control (intermittent operation instruction of the facility equipment 15) is given, the “turn-on” and “turn-off” outputs are sent at constant intervals (intermittent time). The intermittent operation can realize energy saving more than the continuous operation.

The history information of the facility equipment 15 from the control device 4, the control setting information inputted from the display device 3, and input and output score information for monitor and control in the building management system are stored in the database 2 through the server 1.

Next, the entry and exit management system 13 will be described.

The entry and exit management system 13 includes a server 5, the database 6 and the control device 7.

The server 5 stores information gathered by the control device 7 from a personal identification device 10 and an electric lock 11 provided in the room 14 into the database 6. The in-room people number in the room is grasped based on the entry and exit history information outputted from the control device 7 and is stored in the database 6. Incidentally, the server 5 sets the maximum number of people entering the room and stores it in the database 2. The maximum number of people can also be inputted by the user from the display screen.

The database 6 stores the history information of the facility equipment 15, the control information of the electric lock 11, the personal identification information registered in the entry and exit management system, history information such as card operation history and alarm history, and the like .

The control device 7 receives the personal identification information (card number, passage authority information, etc.) and the entry and exit history information registered in the database 6, and outputs the entry and exit history information and the like to the server 1 through the LAN network. Besides, the control device 7 controls the personal identification device (card reader) 10 and the electric lock 11, and collates the card number detected by the personal identification device 10. If the card number is the card number having the passage authority, the control device 7 controls to unlock the electric lock 11. On the other hand, if the card number does not have the passage authority, the control device holds the locked state, so that the entry and exit management system is realized. The entry and exit management system 13 controls the entry and exit to and from the room, so that the in-room people number in the room can be grasped.

Finally, the room 14 will be described.

The room 14 is provided with the facility equipment 15 (the air conditioner facility 8, the lighting facility 9, etc.), the personal identification device (card reader) 10, and the electric lock 11. The facility equipment 15 is connected to the control device 4 through the network, and the personal identification device (card reader) 10 and the electric lock 11 are connected to the control device 7 through the network.

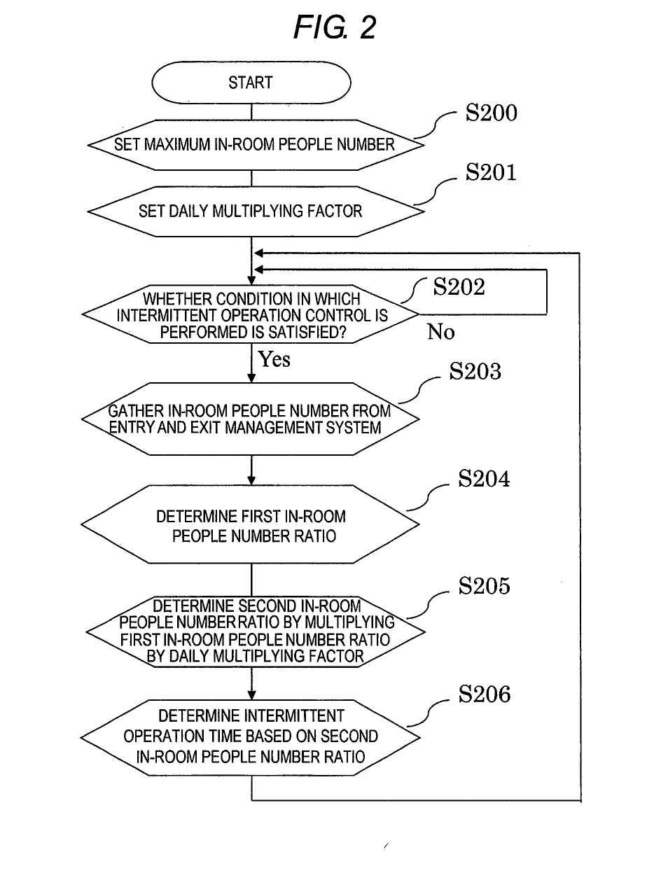

FIG. 2 shows a processing flow of intermittent time calculation. Incidentally, in the following embodiment, it is assumed that the facility equipment 15 is the air conditioner facility 8.

First, in the building management system 13, the maximum number of people entering the room 14 is set (S200). The maximum number of people is determined to be a rough standard.

Next, a multiplying factor (here, a daily multiplying factor) indicating an operation necessity of the facility equipment is set (S201).

The multiplying factor is a numerical value representing the operation necessity of the facility equipment, that is, the operation necessity in view of, for example, the magnitude of temperature change in the room 14 in which the facility equipment 15 is installed, and is set to be a numerical value of, for example, 0.5 to 1.0. In the case where the multiplying factor is set daily, since the number of entering and leaving people and the number of heat sources (lightings, personal computers, etc.) installed in the room are small on a holiday, it is conceivable that the temperature change in the room 14 is small. Thus, it is conceivable that the operation necessity of the facility equipment is not very high. Accordingly, the multiplying factor is set to be a small numerical value (for example, 0.5).

On the other hand, on a week day, even if the number of people is the same as that on a holiday, since the number of entering and leaving people and the number of heat sources (lightings, personal computers, etc.) installed in the room are larger than those on the holiday, it is conceivable that the temperature change in the room 14 is large as compared with the holiday. Thus, the multiplying factor is set to be large as compared with that on the holiday.

The multiplying factor as stated above is adopted, and an intermittent operation control plan is made based on a second in-room people number ratio obtained by multiplying the in-room people number ratio by the multiplying factor. As a result, the intermittent operation control plan in view of the environment in the room 14 can be possible. This intermittent operation control is superior in comfortableness and energy saving effect as compared with intermittent operation control in which the operation control is performed based on only the in-room people number ratio without introducing the multiplying factor.

Incidentally, the multiplying factor may be a daily multiplying factor which is set daily, or a multiplying factor for each time which is set according to a time zone. The multiplying factor is stored as the basic information in the database 2, and can be set from the display device 3. Incidentally, although the multiplying factor can be set as a numerical value, the multiplying factor may be set in such a manner that values are previously determined for seasons and months, and a season is inputted from the display device 3 or the like.

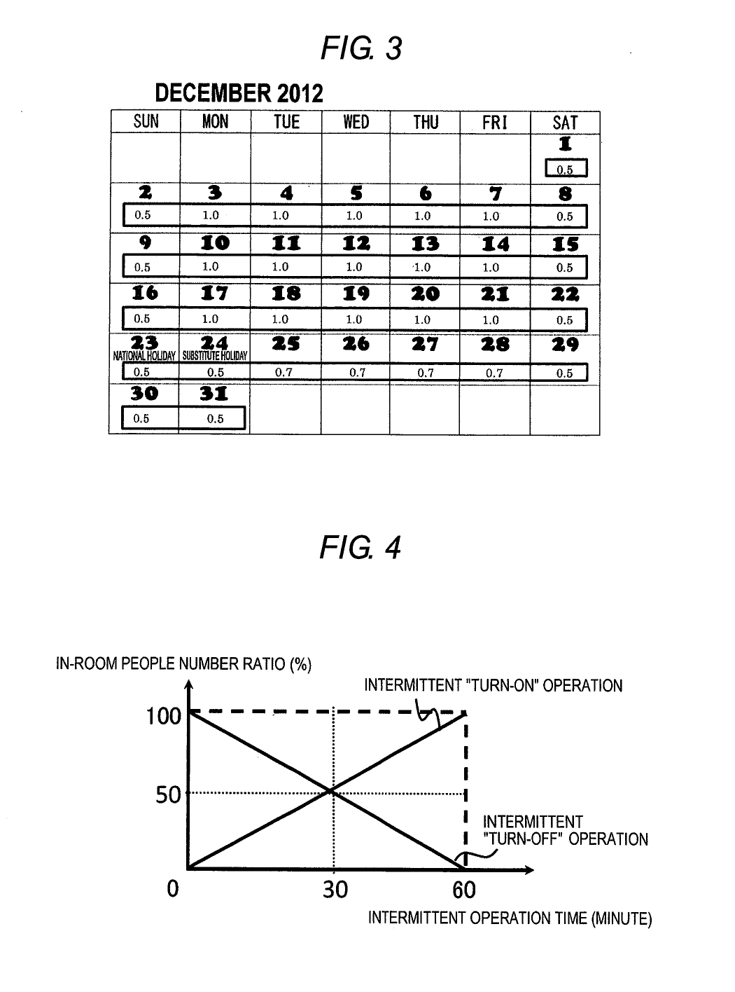

FIG. 3 shows dates and daily multiplying factors. Here, the multiplying factor is set to be 0.5 to 1.0. On a week day, the multiplying factor is set to 1.0, and on a holiday or a date when the operation necessity of the facility equipment 15 is low, the multiplying factor is set to 0.5 or 0.7 which is small as compared with that on the week day.

Return is made to FIG. 2. After S201, the control device 4 determines whether a condition of intermittent operation control is satisfied (S202). Specifically, it is determined that the intermittent operation control is possible when the air conditioner is continuously operated.

If it is determined that the intermittent operation control is possible (Yes at S202), the present in-room people number grasped by the entry and exit management system 13 and stored in the database 6 is inputted to the control device 4 through the LAN (S203). Incidentally, since the in-room people number is changed, it is acquired at a constant period.

On the other hand, if it is determined that the intermittent operation control is impossible (No at S202), the determination of S202 is again performed.

Next, after the in-room people number is gathered at S203, in order to determine the intermittent time, the control device 4 calculates a first in-room people number ratio to the maximum in-room people number in the room (S204).

The first in-room people number ratio (%) is represented by the following expression.

first in-room people number ratio (%)=(in-room people number/maximum in-room people number) * 100

A second in-room people number ratio is calculated by multiplying the first in-room people number ratio obtained at S204 by the daily multiplying factor (S205).

second in-room people number ratio (%)=(in-room people number/maximum in-room people number) * 100 * multiplying factor

Finally, a “turn-on” time and a “turn-off” time in the intermittent operation time are determined based on the second in-room people number ratio calculated at S205 (S206).

intermittent “turn-on” operation time (minute)=intermittent operation control time ×second in-room people number ratio÷100

intermittent “turn-off” operation time (minute)=intermittent operation control time×(100−second in-room people number ratio)÷100

FIG. 4 shows a method of calculating the “turn-on” time and the “turn-off” time in an operation time of one hour based on the second in-room people number ratio. For example, when the intermittent operation time is 60 minutes, the intermittent “turn-on” operation time can be calculated by multiplying the intermittent operation time by the second in-room people number ratio (%). The intermittent time is set so that when the second in-room people number ratio is 50%, the intermittent “turn-on” time and the intermittent “turn-off” time are respectively 30 minutes. Incidentally, the intermittent “turn-on” operation time and the intermittent “turn-off” operation time may not be absolute values, and a ratio in a specified time may be set.

The calculation method of the intermittent “turn-on” operation time on Dec. 2, 2012 will be described with reference to the flow of FIG. 2.

In the case of the intermittent operation control period (S202), the entry and exit management system gathers that the in-room people number is 25 (S203). At this time, the first in-room people number ratio is 25% (S204). Further, the second in-room people number ratio of 12.5% is obtained by multiplying the first in-room people number ratio by 0.5 as the daily multiplying factor set in FIG. 3 (S205). The intermittent operation time is calculated based on the obtained second in-room people number ratio (S206). If the control time is 60 minutes, the intermittent “turn-on” operation time (minute) =intermittent operation control time (60 minutes)×in-room people number ratio (12.5%)÷100=7.5 minutes is obtained. On the other hand, the intermittent “turn-off” operation time (minute)=base intermittent operation time (60 minutes)×(100−in-room people number ratio (12.5%))÷100=52.5 minutes is obtained.

On the other hand, with respect to the intermittent “turn-on” operation time on Dec. 3, 2012, if the in-room people number is 25 while the maximum in-room people number is 100, since the daily multiplying factor is 1.0, the second in-room people number ratio of 25% is obtained by multiplying the first in-room people number ratio of 25% by 1.0. Thus, if the control time is 60 minutes, the “turn-on” operation time (minute)=intermittent operation control time (60 minutes) ×in-room people number ratio (25%)÷100=15 minutes is obtained. On the other hand, the intermittent “turn-off” operation time (minute)=base intermittent operation time (60 minutes)×(100−in-room people number ratio (25%))÷100=45 minutes is obtained.

The intermittent operation is performed based on the intermittent “turn-on” operation time and the intermittent “turn-off” operation time obtained as described above. When the operation control is performed, the previously set intermittent operation plan is used, and the intermittent operation is performed so as to satisfy the obtained intermittent “turn-on” operation time and the intermittent “turn-off” operation time.

As described above, in this embodiment, the intermittent operation plan is created using the daily multiplying factor, so that the suitable intermittent operation can be performed according to the room environment. An air conditioner facility whose operation control is performed based on temperature may continue to operate so as to satisfy the set temperature. On the other hand, in the intermittent operation of this embodiment, the intermittent operation is performed according to the environment in the room. Thus, the operation time of the air conditioner facility can be reduced more certainly, and this embodiment can contribute to the energy saving.

1. A building management system comprising a facility equipment and a control device to control the facility equipment, wherein
the control device obtains an operation time in an intermittent operation of the facility equipment based on a second in-room people number ratio obtained by multiplying a first in-room people number ratio, which is a ratio of an actual in-room people number to a maximum in-room people number in an area where the facility equipment is provided, by a multiplying factor whose value becomes large as an operation necessity of the facility equipment becomes high.

2. The building management system according to claim 1, wherein the operation time is obtained by multiplying an intermittent operation control time of the facility equipment by the second in-room people number ratio.

3. The building management system according to claim 1, further comprising a display device capable of inputting and outputting information on control of the facility equipment, wherein the multiplying factor is inputted from the display device.

4. The building management system according to claim 1, wherein the multiplying factor is set for at least one of every day, every month and every season.

5. The building management system according to claim 2, further comprising a display device capable of inputting and outputting information on control of the facility equipment, wherein the multiplying factor is inputted from the display device.
